(19) United States
(12) Patent Application Publication
(10) Pub. No.: US 2014/0109713 A1
(43) Pub. Date: Apr. 24, 2014

(54) ON CENTER ACTUATING LEVER WITH CROSS AXIS RAKE AND TELESCOPE LOCK

(71) Applicant: STEERING SOLUTIONS IP HOLDING CORPORATION, Saginaw, MI (US)

(72) Inventor: Joen C. Bodtker, Gaines, MI (US)

(73) Assignee: Steering Solutions IP Holding Corporation, Saginaw, MI (US)

(21) Appl. No.: 13/656,018

(22) Filed: Oct. 19, 2012

(51) Int. Cl. B62D 1/187

(52) U.S. Cl. 74/493

(57) ABSTRACT

An adjustable steering column assembly is provided. The assembly includes a rake bracket having a first leg and a second leg, a steering shaft extending within an upper jacket along a first axis between the first and second legs, a telescope clamp positioned about the upper jacket and a telescope lock connected to the telescope clamp to selectively apply a first clamping force to the upper jacket to secure the steering shaft against adjustment in a telescope direction. An actuating lever is coupled to a rake bolt, the rake bolt extending along a second axis intersecting the telescope clamp and is rotatable by the actuating lever. A rake lock is positioned on the rake bolt and selectively applies a second clamping force between the rake bracket and telescope clamp to secure the steering shaft against adjustment in the rake direction. A lash adjusting device is coupled to the telescope clamp for adjusting lash.

### BACKGROUND OF THE INVENTION

The following description relates to a rake and telescope lock of an adjustable steering column assembly having an on center actuating lever, the rake and telescope lock operable and individually and separately tunable.

Adjustable steering columns may be adjustable in a rake direction and a telescope direction. A traditional adjustable steering column includes a jacket clamp positioned about a steering column jacket and configured to apply a clamping force to the steering column jacket to prevent adjustment of the steering column in the telescope direction. In addition, a traditional adjustable steering column may include a rake clamp configured to apply a clamping force to the jacket clamp and/or steering column jacket to prevent adjustment of the steering column in the rake direction. The adjustable steering column is in a locked condition when the telescope clamp and rake clamp respectively apply clamping forces to prevent adjustment of the adjustable steering column in the rake and telescope and directions. The adjustable steering column is in an unlocked condition when respective clamping forces from the telescope clamp and rake clamp are released so that the steering column may be adjusted.

A lever may be actuated to rotate a bolt extending through the rake clamp and jacket clamp to move the rake clamp and jacket clamp between the locked and unlocked conditions. That is, rotation of the bolt in one direction causes the rake clamp and jacket clamp to apply a clamping force to lock the steering column against adjustment. Rotation of the bolt in an opposite direction causes the rake clamp and jacket clamp to release a clamping force to unlock the steering column such that the steering column may be adjusted in the rake and telescope directions.

Adjustable steering columns are generally designed and manufactured with five performance characteristics in mind: 1) high stiffness while clamped or locked, 2) high holding load while clamped or locked, 3) low resistance to adjustment while unclamped or unlocked, in two axes of motion, 4) low effort to actuate a lever between positions corresponding to clamped and unclamped conditions of adjustable steering assembly, and 5) low travel distance for the lever when actuating the adjustable steering column between clamped and unclamped conditions. Typically, certain performance characteristics must be sacrificed in order to improve others. For example, a reduction in the travel distance for the lever to lock the adjustable steering column has traditionally increased the effort required to actuate the lever. Conversely, when effort to actuate the lever is reduced, stiffness and holding load tend to be reduced as well. In addition, the travel distance for the lever to actuate the adjustable steering column increases.

Further, in the traditional adjustable steering columns, the jacket clamp and rake clamp are adjusted together via rotation of the bolt extending along a single axis. As a result, the jacket clamp and rake clamp cannot be individually tuned or adjusted to be installed in different applications. That is, any lash adjustment along the bolt is applied equally to the rake clamp and jacket clamp.

Further still, in traditional adjustable steering columns, the bolt and lever are spaced from the steering shaft. However, this configuration may use additional space in and around the steering column assembly and possibly interfere with passenger movement.

Accordingly, it is desirable to provide and adjustable steering column assembly where clamped/locked holding load and unclamped/unlocked adjustment effort performance characteristics are met, while also satisfying performance characteristics related to the effort required to actuate the lever between clamped and unclamped positions. In addition, it is desirable to provide an adjustable steering column where lash along a rake lock and jacket lock may be individually adjusted. Further still, it is desirable to reduce the space occupied by the steering column assembly by moving an axis of rotation of the lever to an on center location so that it is not spaced from the axis of the steering shaft.

### SUMMARY OF THE INVENTION

According to an exemplary embodiment, there is provided an adjustable steering column assembly, adjustable in rake and telescope directions, including a rake bracket having a first leg and a second leg, a steering shaft extending within an upper jacket along a first axis between the first leg and second leg, a telescope clamp positioned about the upper jacket and a telescope lock connected to the telescope clamp and configured to operate the telescope clamp to selectively apply a first clamping force to the upper jacket to secure the steering shaft against adjustment in a telescope direction. An actuating lever is coupled to a rake bolt, the rake bolt extending along a second axis and rotatable by the actuating lever, the second axis intersecting the telescope clamp. A rake lock is positioned on the rake bolt and configured to selectively apply a second clamping force between the rake bracket and telescope clamp to secure the steering shaft against adjustment in the rake direction. A lash adjusting device is coupled to the telescope clamp and configured to adjust lash along the second axis.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of an adjustable steering assembly in accordance with an exemplary embodiment of the present invention;

FIG. 2 is a side view of the adjustable steering assembly of FIG. 1 in accordance with an exemplary embodiment of the present invention;

FIG. 3 is a front cross-section view taken along A-A in FIG. 2 of the adjustable steering assembly in accordance with an exemplary embodiment of the present invention;

FIG. 4 is a front view of the adjustable steering column of FIG. 1 in accordance with an exemplary embodiment of the present invention;

FIG. 5 is a cross-section view taken along B-B in FIG. 4 of the adjustable steering assembly in accordance with an exemplary embodiment of the present invention; and

FIG. 6 is a cross-section taken along C-C in FIG. 4 of the adjustable steering assembly in accordance with an exemplary embodiment of the present invention.

### DETAILED DESCRIPTION

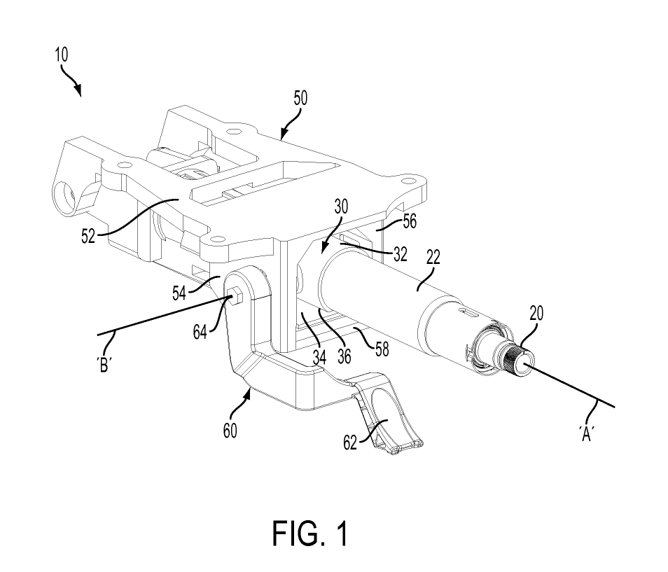

Referring now to the Figures, where the invention will be described with reference to specific embodiments, without limiting same, FIG. 1 is a perspective view of an adjustable steering column assembly 10 according to an exemplary embodiment of the present invention. The steering column assembly 10 includes a steering shaft 20 extending along a first axis ‘A’. A steering wheel (not shown) is attached to one end of the steering shaft. Another end of the steering shaft 20 is coupled a steering gear (not shown).

An upper jacket 22 surrounds and supports the steering shaft 20. In an exemplary embodiment, the upper jacket 22 extends coaxially with the steering shaft 20 and a plurality of bearings are disposed between the upper jacket 22 and steering shaft 20. The steering shaft 20 is rotatably connected to the upper jacket 22 and is axially retained within the upper jacket 22 during normal adjusting operations.

A lower jacket, or telescope clamp 30, at least partially surrounds and supports the upper jacket 22. The telescope clamp 30 includes a body portion 32 which, in an exemplary embodiment, extends substantially around an outer circumference of the upper jacket 22 and extends coaxially with the upper jacket 22. An inner circumference of the body portion 32 substantially matches an outer circumference of the upper jacket 22.

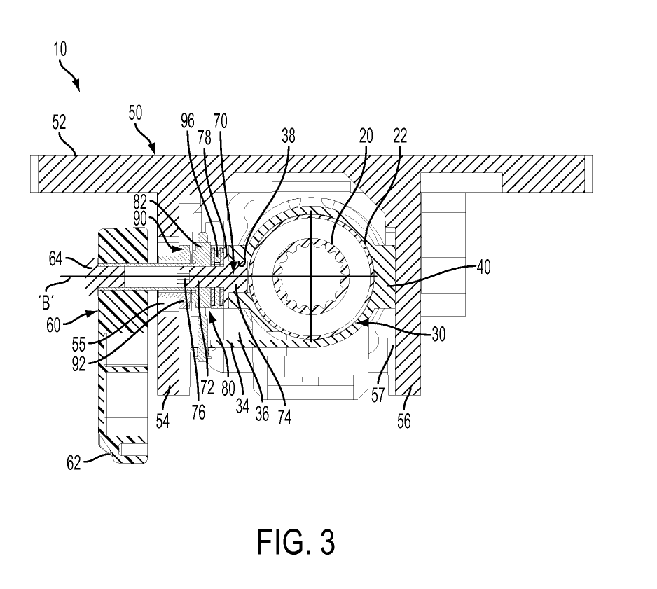

The telescope clamp 30 also includes a clamping leg 34 that extends outwardly or away from the body portion 32. In an exemplary embodiment, the clamping leg 34 extends generally tangentially from a point along the body portion 32, but is not limited to such a configuration. A gap 36 is formed between the clamping leg 34 and the body portion 32 of the telescope clamp 30 (see FIG. 3 also).

With further reference to FIG. 1, the steering column assembly 10 also includes a rake bracket 50. In an exemplary embodiment, the rake bracket 50 is formed as a box section rake bracket and includes a mounting section 52, a first leg 54 and a second leg 56. The mounting section 52 is configured to be secured to an adjacent vehicle component by suitable fasteners. In an exemplary embodiment, the mounting section 52 includes at least one opening configured to receive a fastener to be secured to the adjacent vehicle component.

The first leg 54 extends from the mounting section 52. In an exemplary embodiment, the first leg 54 extends generally perpendicularly from the mounting section 52, but is not limited to such a configuration. The second leg 56 is spaced from the first leg 54 and extends from the mounting section 52. In an exemplary embodiment, the second leg 56 extends generally perpendicularly from the mounting section 52 and parallel to the first leg 54. However, it is understood that the present invention is not limited to this configuration, and the second leg 56 may extend from the mounting section 52 at a non-perpendicular angle and may be non-parallel to the first leg 54. The first leg 54 and second leg 56 are spaced apart to receive to the telescope clamp 30, the upper jacket 22 and steering shaft 20 therebetween.

A cross leg 58 may extend between the first leg 54 and second leg 56 at an end of the first leg 54 and second leg 56 opposite from the mounting bracket 52. Accordingly, the rake bracket 50 may be formed generally as a box to increase stiffness of the bracket 50.

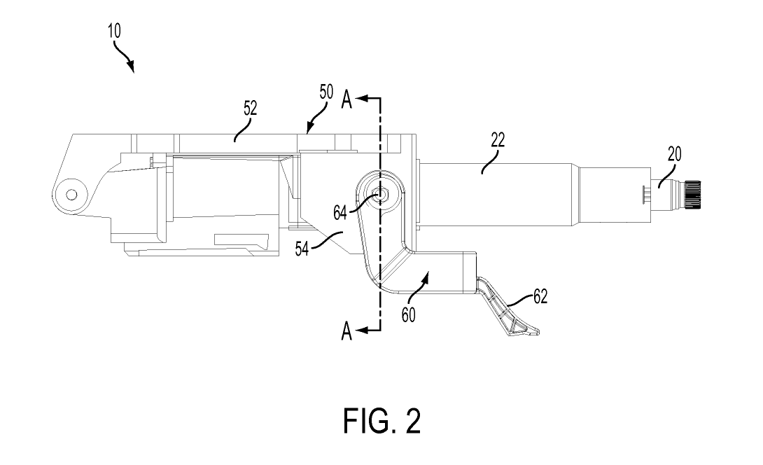

With reference to FIGS. 1 and 2, the steering column assembly 10 also includes an actuating lever 60. The actuating lever 60 includes a handle portion 62 and is rotatable about a second axis ‘B’. A rake bolt 64 extends along the second axis ‘B’ and is coupled to the actuating lever to rotate with the actuating lever 60.

FIG. 3 is a cross-section taken at A-A in FIG. 2. With reference to FIG. 3, the second axis ‘B’ is positioned to intersect the telescope clamp 30. In an exemplary embodiment, the second axis ‘B’ intersects the first axis ‘A’ of the steering shaft 20. Also, in an exemplary embodiment, the rake bolt 64 extends along the second axis ‘B’ through the first leg 54 of the rake bracket 50. Thus, the rake bolt 64 and actuating lever 60 are on center with the steering shaft 20. The rake bolt 64 interfaces with a lash adjusting device 70, a telescope lock 80 and a rake lock 90.

Referring to FIG. 3, the telescope clamp 30 further includes an opening 38 configured to be coupled with the lash adjusting device 70 and a post 40 configured to cooperate with the second leg 56 of the rake bracket 50. In an exemplary embodiment, the opening 38 of the telescope clamp is threaded.

The rake bracket 50 includes an adjustment slot 55 formed in the first leg 54. The rake bolt 64 extends from the actuating lever 60 through the adjustment slot. The adjustment slot 55 accommodates movement of the rake bolt 64 in a rake direction during adjustment of the steering shaft 20 in the rake direction.

The second leg 56 of the rake bracket 50 includes a guide slot 57. The guide slot 57 is configured to receive the post 40 of the telescope clamp 30. During adjustment in the rake direction, the post 40 rides in the guide slot 57. Accordingly, loads may be shared between the telescope clamp 30 and binding may be prevented.

The lash adjusting device 70 includes a first end 72 and a second end 74. The first end 72 extends within a hollow section of the rake bolt 64 and includes an adjusting head 76 that is accessible through the rake bolt 64. The second end 74 is coupled with the opening 38 of the telescope clamp 30. In an exemplary embodiment, the second end 74 is threaded and is threadably engaged with the opening 38. The lash adjusting device 70 may be rotatably adjusted at the adjusting head 76 so that the second end 74 rotates in the opening 38, causing the lash adjusting device 70 to move axially along the second axis ‘B’ due to the threaded engagement with the opening 38. The lash adjusting device 70 may also include a collar 78 which may be urged into contact with a portion of the telescope clamp 30 adjacent to the opening 38.

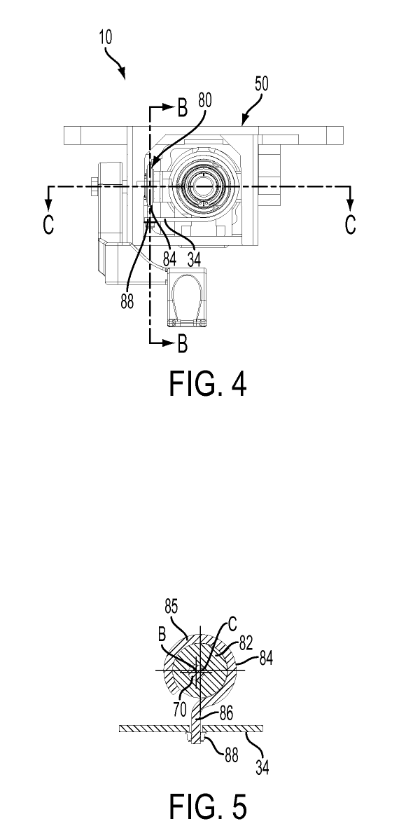

FIG. 4 is a front view of the steering column assembly 10 according to an exemplary embodiment of the present invention. With reference to FIGS. 3 and 4, the telescope lock 80 includes an eccentric block 82, a link 84 and a lock nut 88. The eccentric block 82 is positioned on the rake bolt 64 and may be formed integrally with the rake bolt 64 or fastened to the rake bolt so that the eccentric block 82 rotates with the rake bolt 64.

FIG. 5 is a cross section taken at B-B in FIG. 4 and shows the telescope lock 80 looking along the second axis ‘B’. In an exemplary embodiment, the link 84 includes a first portion 85 and a second portion 86. The first portion 85 extends substantially around an outer circumference of the eccentric block 82. The second portion 86 extends away from the eccentric block 82 and is connected to the clamping leg 34 of the telescope clamp 30. In an exemplary embodiment, the second portion 86 extends through an aperture in the clamping leg 34. The lock nut 88 is threaded onto an end of the second portion 86 and may apply a force to the clamping leg 34 to adjust lash along the telescope lock 80. In an exemplary embodiment, the lock nut 88 is a nylon lock nut and is secured against unintentional adjustment. Unintentional adjustment may otherwise occur during operation due to, for example, vibrations within the steering assembly.

The terminology “lash”, as used herein, may refer to, for example, gaps between parts which may result from a manufacturing process. Such gaps may result in lost motion during operation of the telescope lock. For example, an input motion may not result in a corresponding output motion while the gaps are being taken up. In an exemplary embodiment, the lock nut 88 may be adjusted after the telescope lock 80 is initially assembled to take up any gaps between the parts of the telescope lock along the link 84 and between the telescope clamp 30 and upper jacket 22, thereby preventing or reducing lost motion during operation.

With further reference to FIG. 5, the lash adjusting device 70 is shown centered on the second axis ‘B’. The lash adjusting device 70 extends coaxially with the rake bolt 64. The eccentric block 82 is shown positioned on a third axis ‘C’, spaced from the second axis ‘B’. Accordingly, rotation of the rake bolt 64 along the second axis ‘B’ causes the eccentric block to rotate eccentrically thereabout. The eccentric block 82 causes the link 84 to move to eccentrically about the rake bolt 64. Thus, the link 84, during eccentric movement, applies or releases a force to the clamping leg 34 of the telescope clamp 30 via the lock nut 88. In turn, the clamping leg 34 deflects and applies or releases a first clamping force to the upper jacket 22.

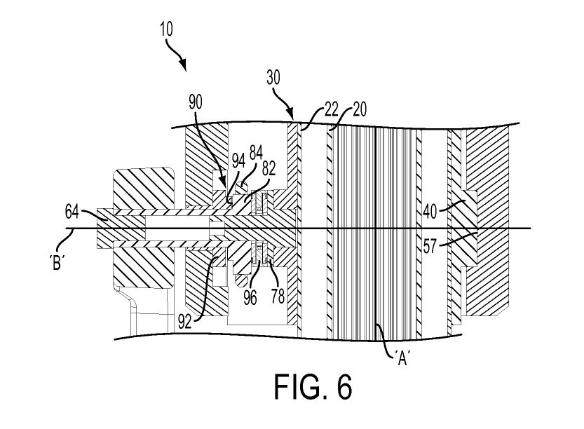

FIG. 6 is a top view cross section take along C-C in FIG. 4. With reference to FIGS. 3 and 6, the rake lock 90 is positioned along the rake bolt 64. In an exemplary embodiment, the rake lock 90 is a cam mechanism configured to apply or release a second clamping force along the second axis ‘B’. The cam mechanism may include a first cam part and a second part positioned adjacent to each other on the rake bolt 64. One cam part is configured to rotate with the rake bolt 64 while the other is fixed against rotation. The first cam part and second part are interfaced so that rotation of one cam part relative to the other causes axial movement of one cam part relative to the other. By moving the first cam part and second part axially away from one another, the second clamping force is applied to components positioned along the second axis ‘B’.

The cam mechanism may be any suitable cam mechanism where rotation of one part relative to another causes axial movement of one cam part relative to the other along the second axis ‘B’. For example, the cam mechanism may be a friction cam where each cam part includes at least one recess and at least one projection. As additional non-limiting examples, the cam mechanism may be a pin type cam or a ball and ramp type cam.

In an exemplary embodiment, and with reference to FIGS. 3 and 6, the rake lock 90 is a cam mechanism which includes a first cam part 92 and the eccentric block 82 acting as a second cam part. In an exemplary embodiment, an axial face of the eccentric block 82 facing the first cam part 92 includes a cam face 94 that is interfaced with the first cam part 92. As noted above, the interface between the cam face 94 and first cam part 92 may include at least one projection and at least one corresponding recess rotatable relative to one another, at least one pin movable between an extend position and a retracted position, or a ball and ramp configuration. It is understood that other suitable cam configurations are envisioned as well. For example, the cam face 94 may be formed on a separate cam part that is slidably but non-rotatably connected to the rake bolt 64 or the eccentric block 82.

In an exemplary embodiment, rotation of the rake bolt 64 by the actuating lever 60 in a first direction causes the eccentric block 82 to rotate in a locking direction. During this rotation, the cam face 94 of the eccentric block 82 interfaces with the first cam part 92. For example, a peak of an axial projection of the cam face 94 may come into contact with a peak of a corresponding axial projection of the first cam part 92 and cause the first cam part 92 to move axially along the rake bolt 64 away from the eccentric block 82. Accordingly, the second clamping force is applied to the first leg 54 of the rake bracket and telescope clamp 30 and the second leg 56 of the rake bracket 50 via the telescope clamp 30. In turn, the telescope clamp 30, upper jacket 22 and steering shaft 20 are secured against adjustment in the rake direction.

A thrust bearing 96 may be positioned along the second axis ‘B’ between the eccentric block 82 and the collar 78 of the lash adjusting device 70. The thrust bearing 96 may reduce friction between the eccentric block 82 and the collar 78 of the lash adjusting device 70 to aid in rotation of the eccentric block 82.

Also, as noted above, rotation of the eccentric block 82 causes the first clamping force to be applied or released from the upper jacket 22. Rotation of the actuating lever 60 in the first direction, as described above, causes the rake bolt 64 to rotate, and in turn, the eccentric block 82 rotates in a locking direction. Rotation of the eccentric block 82 causes the link 84 to move in a direction where a force is applied to the clamping leg 34 via the lock nut 88 and the clamping leg 34 is deflected toward the second axis ‘B’. Deflection of the clamping leg 34 in this direction causes the telescope clamp 30 to apply the first clamping force to the upper jacket 22. With the first clamping force applied to the upper jacket 22, the upper jacket 22 and steering shaft 20 are secured against adjustment in a telescope direction.

Rotation of the of the actuating lever 60 in a second direction, opposite to the first direction, causes the rake bolt 64 and eccentric block 82 to rotate in an unlocking direction. During rotation in the unlocking direction, the first cam part 92 moves axially toward the cam face 94. For example, the projection of the cam face 94 may move into engagement with a recess of the first cam part 92, which is urged axially toward the eccentric block under the second clamping force, thereby reducing the axial space occupied by the rake lock 80 and releasing the second clamping force from the components in positioned between the first leg 54 and second leg 56 of the rake bracket 50. With the second clamping force released, the upper jacket 22 and steering column 20 are moveable with the telescope clamp 30 in the rake direction relative to the rake bracket 50 between the first leg 54 and second leg 56. Accordingly, the steering shaft 20 may be adjusted in the rake direction.

Rotation of the eccentric block 82 in the unlocking direction causes the link 84 to move in a direction where the clamping leg 34 may move away from the second axis ‘B’. The clamping leg 34 may be urged in a direction away due to an internal spring force created when the clamping leg was deflected toward the second axis ‘B’. Movement of the clamping leg 34 away from the second axis ‘B’ causes the first clamping force to be released from the upper jacket 22. With the first clamping force released, the upper jacket 22 and steering shaft are movable together in the telescope direction relative to the telescope clamp 30 and rake bracket 50. According, the steering shaft 20 may be adjusted in the telescope direction.

Thus, in the exemplary embodiment above, the first and second clamping forces may be applied and released by rotation of the actuating lever 60 in the first direction and second direction, respectively. In addition, lash along each of the locking components, i.e., the telescope lock 80 and the rake lock 90 may be individually adjusted. Adjustment of lash along the telescope lock 80 may also adjust lash between telescope clamp 30 and the upper jacket 22. As noted above, “lash” refers to gaps formed between parts in the assembly during manufacturing.

In an exemplary embodiment, the lash adjusting mechanism 70 is operated with the assembly in an unloaded condition, i.e., with no clamping force applied along the second axis ‘B’. The lash adjusting mechanism 70 may be adjusted to account for lash along the second axis ‘B’ by adjusting head 76, which may be accessed through an outer end of the hollow rake bolt 64. Rotation of the lash adjusting mechanism 70 causes the lash adjusting mechanism 70 to move axially along the second axis ‘B’ due to the threaded engagement in the opening 38 of the telescope clamp. Movement in this axial direction may bring components positioned along closer together to eliminate gaps formed therebetween as a result of normal manufacturing variation of the individual components. For example, with reference to FIGS. 3 and 6, axial movement of the lash adjusting mechanism 70 may move the thrust bearing 96 toward the eccentric block 82, eliminating or minimizing any gap formed therebetween resulting from manufacturing and/or assembly. As a result, lost motion during rotation of the actuating lever 60 may be reduced or eliminated. The lash adjusting mechanism 70 may retain its setting with conventional means of thread locking.

Similarly, as described above, the lock nut 88 may be adjusted with the telescope lock in an unloaded condition, i.e., with no clamping force applied, to remove lash along the telescope lock 80 and between the telescope clamp 30 and the upper jacket 22.

By using threaded lash adjustment devices, such as the lash adjusting device 70 and the lock nut 88 described in the exemplary embodiments above, it is not necessary to pre-compress or pre-load static elastic members to set the lash. Rather, the threaded adjustment device may set the gap or gaps to whatever tolerance is required or desired for a particular application, regardless of part to part dimensional variation. Thus, when a lock mechanism, such as the rake lock 90 is in an unclamped condition, there is no bracket drag resulting from a pre-load of elastic elements to increase rake adjustment effort. In addition, in the exemplary embodiments above, gaps along the separate axes of motion are no longer additive, so that for a given direction of adjustment, increased mechanical advantage may be realized.

Effort required to operate the actuating lever 60 may also be reduced by optimizing the interface between the cam parts for the greatest mechanical advantage. Further still, a free-state gap between the brackets is better controlled and minimized by decoupling the rake and telescope motions clamping motions. This may yield more opportunity to reduce effort required to operate the actuating lever 60.

Because the telescope lock 80 and rake lock 90 are decoupled from each other, the performance characteristics of the steering column assembly 10 may be met by individually adjusting lash for each of the telescope lock 80 and rake lock 90. For example, in the exemplary embodiments described above, a high hold loading while clamped and low resistance to adjustment may be met, while still meeting desired performance characteristics for low actuating lever effort. The telescope lock 80 may be tuned to suit the stiffness of a particular joint, and gaps along the telescope lock 80 may be adjusted with lock nut 88 to account for part to part variations. Further, the lash adjusting device 70 may be adjusted to meet performance characteristics regarding rake adjustment without affecting telescoping adjustment performance characteristics.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. An adjustable steering column assembly, adjustable in rake and telescope directions, comprising:
a rake bracket comprising a first leg and a second leg;
a steering shaft extending within an upper jacket along a first axis between the first leg and second leg;
a telescope clamp positioned about the upper jacket;
a telescope lock connected to the telescope clamp and configured to operate the telescope clamp to selectively apply a first clamping force to the upper jacket to secure the steering shaft against adjustment in a telescope direction;
an actuating lever coupled to a rake bolt, the rake bolt extending along a second axis and rotatable by the actuating lever, the second axis intersecting the telescope clamp;
a rake lock positioned on the rake bolt and configured to selectively apply a second clamping force between the rake bracket and telescope clamp to secure the steering shaft against adjustment in the rake direction; and
a lash adjusting device coupled to the telescope clamp and configured to adjust lash along the second axis.

2. The adjustable steering column assembly of claim 1, wherein the telescope lock comprises an eccentric block eccentrically positioned on and rotatable with the rake bolt, a link having a first portion extending about a circumference of the eccentric portion and a second portion extending from the first portion, the second portion connected to the telescope clamp.

3. The adjustable steering column assembly of claim 2, wherein the telescope clamp comprises a body portion at least partially surrounding the upper jacket and a clamping leg extending outwardly from the body portion, the second portion of the link connected to the clamping leg.

4. The adjustable steering column assembly of claim 3, the telescope lock further comprising a lock nut attached to the second portion of the link, the lock nut configured to adjust lash along the link and between the telescope clamp and upper jacket.

5. The adjustable steering column assembly of claim 1, wherein the second axis intersects the first axis.

6. The adjustable steering column assembly of claim 1, wherein the lash adjusting device is positioned between the telescope clamp and rake bolt and extends at least partially within the rake bolt.

7. The adjustable steering column assembly of claim 6, wherein the lash adjusting device is threadably coupled to the telescope clamp and rotation of the lash adjustment device causes the lash adjustment device to move in the direction of the second axis.

8. The adjustable steering column assembly of claim 3, wherein the rake lock comprises a cam mechanism, the cam mechanism comprising a first cam part axially moveable along the rake bolt and a cam face formed on an axial face of a second cam part, the first cam part and cam face interfaced so that rotation of the cam face causes the first cam part to move axially along the rake bolt.

9. The adjustable steering column assembly of claim 8, wherein the cam face is formed on the eccentric block.

10. The adjustable steering column assembly of claim 9, wherein rotation of the actuating lever in a first direction causes the eccentric block to rotate in a locking direction and rotation of the eccentric block in the locking direction causes the link to move the clamping leg toward the second axis to apply the first clamping force to the upper jacket and causes the first cam part to move axially away from the eccentric block to apply the second clamping force between the first leg and the telescope clamp.

11. The adjustable steering column assembly of claim 10, wherein rotation of the actuating lever in a second direction causes the eccentric block to rotate in an unlocking direction and rotation of the eccentric block in the unlocking direction causes the link to move the clamping leg away from the second axis to release the first clamping force from the upper jacket and causes the first cam part to move axially toward from the eccentric block to release the second clamping force between the first leg and the telescope clamp.

12. The adjustable steering column assembly of claim 1, wherein the first leg of the rake bracket includes an adjustment slot and the rake bolt extends through and is movable within the adjustment slot during adjustment of the steering shaft in the rake direction.

13. The adjustable steering column assembly of claim 1, wherein the telescope clamp further comprises a post and the second leg further comprises a guide slot configured to receive the post, the post slidable within the guide slot during adjustment of the steering column in the rake direction.

14. The adjustable steering column of claim 1, wherein the telescope lock is configured to apply the first clamping force and the rake lock is configured to apply the second clamping force in response to rotation of the rake bolt in a first direction.

15. The adjustable steering column of claim 13, wherein the rake lock moves along the second axis to apply the second clamping force and the telescope lock moves in a direction that intersects the second axis to apply the first clamping force.

16. The adjustable steering column of claim 1, the telescope lock further comprising a lock nut configured to adjust lash along the telescope lock and between the telescope clamp and upper jacket independent of lash adjustment along the second axis by the lash adjusting device.
